(19) United States
(12) Patent Application Publication
(10) Pub. No.: US 2003/0000513 A1
(43) Pub. Date: Jan. 2, 2003

(54) Switchable combustion system for a convection oven

(76) Inventors: James T. Cole, Algonquin, IL (US); Donald E. Fritzsche, Chicago Heights, IL (US); David W. Harter, New Port Richey, FL (US); Ronald Jay Forni, Littleton, MA (US); Malcolm Reay, Drums, PA (US); Jerry Sank, Palm Harbor, FL (US); David McFadden, Lexington, MA (US); Douglas S. Jones, New Port Richey, FL (US)

Correspondence Address: Pauley Peterson Kinne & Fejer, Suite 365, 2800 W. Higgins Road, Hoffman Estates, IL, 60195, US

(21) Appl. No.: 09/892,841

(22) Filed: Jun. 27, 2001

(51) Int. Cl. A21B 1/28

(52) U.S. Cl. 126/21 A

(57) ABSTRACT

A convection oven having a gas combustion system that is switchable between a direct-fired combustion system and an indirect-fired combustion system by a damper moveable between a closed position and an open position. In one preferred embodiment, a separate heat exchange element supplies combustion products to the convection oven.

### BACKGROUND OF THE INVENTION

1. Field of the Invention

This invention relates to a convection oven having a switchable combustion system permitting the convection oven to operate as a direct-fired combustion system and an indirect-fired combustion system.

2. Description of Related Art

Conventional convection ovens are heated by either a direct-fired combustion system or an indirect-fired combustion system. Direct-fired combustion systems circulate combustion products within the cooking space and in direct contact with the food being cooked. These direct-fired combustion systems are a key contributor to the “pinking” of meat, particularly poultry, common in direct-fired convection ovens.

Researchers have concluded that nitrogen dioxide present in the muscle tissue of the meat product combines readily with combustion gas fumes. As a result, the cooked meat product has a bright red color on the surface which may extend one-eighth to one-fourth of an inch inward. This result is greater if the meat is uncovered during the cooking process and/or cooked in a poorly ventilated oven.

In indirect-fired combustion systems, the combustion products do not circulate within the cooking space. In an indirect-fired gas oven, heat generated during the combustion process is exchanged with air in the cooking space by means of a heat exchange device. Because the combustion products never directly contact the food, indirect-fired gas ovens create an environment more suitable for the introduction of steam into the cooking space. However, these ovens are not as efficient as the direct-fired gas ovens, having a slow heat-up time and slow recovery capability.

It is apparent that there is a need for a commercial convection oven having a switchable combustion system permitting the oven to function as a directfired combustion system and an indirect-fired combustion system.

### SUMMARY OF THE INVENTION

It is an object of this invention to provide a convection oven having a switchable combustion system permitting the convection oven to operate as a direct-fired combustion system, having rapid heat-up and recovery capabilities, or an indirect-fired combustion system, creating an environment more suitable for the introduction of steam and/or suitable for cooking without concerns with interactions between the combustion products and the food being cooked.

The above object and further objects of this invention are accomplished with a convection oven having a duct positioned adjacent a cooking chamber and extending into the cooking chamber.

The duct is connected to a gas combustion system having at least one burner connected to a gas supply or fuel source. The convection oven according to different embodiments of this invention may be heated by a gas combustion system having an induced draft, a forced draft and/or a natural draft system, with or without a convection fan. As the gas supplied to the burner combusts, combustion products are generated. A damper is further connected with respect to the duct.

In one embodiment of this invention, when the damper connected to the duct is in the closed position, the convection oven is preferably heated by a direct-fired combustion system. The combustion products generated by the gas combustion system are drawn through the duct by a convection blower mounted within the cooking chamber. As the combustion products are drawn into the cooking chamber, the combustion products circulate through the cooking chamber and make direct contact with the food being cooked. After circulating through the cooking chamber, the combustion products exit the cooking chamber through a vent and into ambient air.

When the damper is in the open position, the convection oven is heated by an indirect-fired combustion system. As the combustion products generated by the gas combustion system travel through the duct, heat is transferred from within the duct into the cooking chamber through a heat exchanger. The combustion products exit the duct through a flue connected to the duct and are prevented from being drawn into the cooking chamber by the damper. As heat exchange occurs, the convection blower circulates the heated air within the cooking chamber. In one preferred embodiment of this invention, after circulating through the cooking chamber, the circulated heated air can be reused, with any excess heated air exiting the cooking chamber through the vent. In the indirect-fired combustion system, the combustion products do not directly contact the food being cooked.

In another preferred embodiment of this invention, a separate heat exchange element is provided. A blower plenum is positioned adjacent the cooking chamber. An inlet baffle is positioned between the blower plenum and the cooking chamber. Preferably, the inlet baffle has a plurality of apertures. The blower plenum is in communication with the cooking chamber.

A gas combustion system is mounted within the blower plenum having a gas manifold connected at a first end to the gas supply and at a second end to at least one gas outlet. A burner is connected to each gas outlet.

A heat exchange element mounted within the blower plenum, for example a heat exchange tube, is connected to each burner and extends into a header. The header is in communication with the gas supply so that the combustion products produced in the gas combustion system travel through the heat exchange element and are collected within a volume of the header. An inducer having a valve that is moveable between an open position, wherein the convection oven operates as an indirect-fired combustion system, and a closed position, wherein the convection oven operates as a direct-fired combustion system is connected to the header.

At least one convection impeller is mounted within the blower plenum and adjacent the heat exchange element. As the convection impeller generates airflow across the heat exchange tubes, heat is transferred from the heat exchange tubes to the air flowing across the heat exchange tubes.

The heated air is forced into the cooking chamber by the convection impeller and circulates within the cooking chamber. Apertures in the inlet baffle allow circulated air within the cooking chamber to be drawn into the blower plenum by at least one convection impeller which recirculates the drawn air across the heat exchange element.

### BRIEF DESCRIPTION OF THE DRAWINGS

The drawings show different features of a convection oven having a combustion system switchable between a direct-fired combustion system and an indirect-fired combustion system, according to preferred embodiments of this invention, wherein:

FIG. 1a is a schematic view of a convection oven having a direct-fired combustion system, according to one preferred embodiment of this invention;

FIG. 1b is a schematic view of a convection oven having an indirect-fired combustion system, according to one preferred embodiment of this invention; and

FIG. 2 is a perspective side view of a convection oven having a combustion system switchable between a direct-fired combustion system and an indirect-fired combustion system with a separate heat exchange element.

### DETAILED DESCRIPTION OF PREFERRED EMBODIMENTS

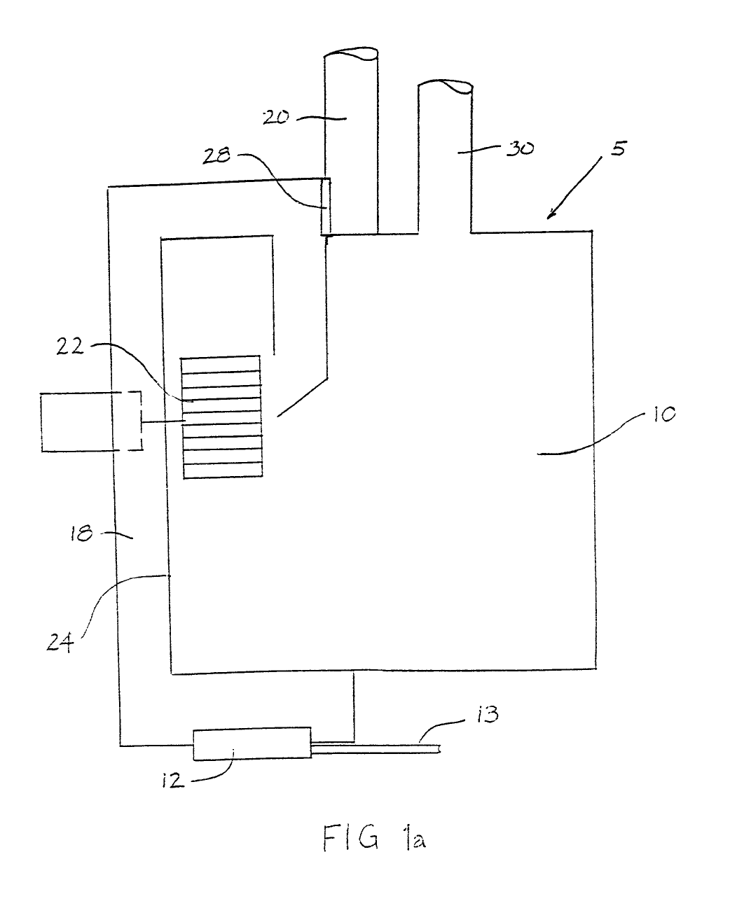

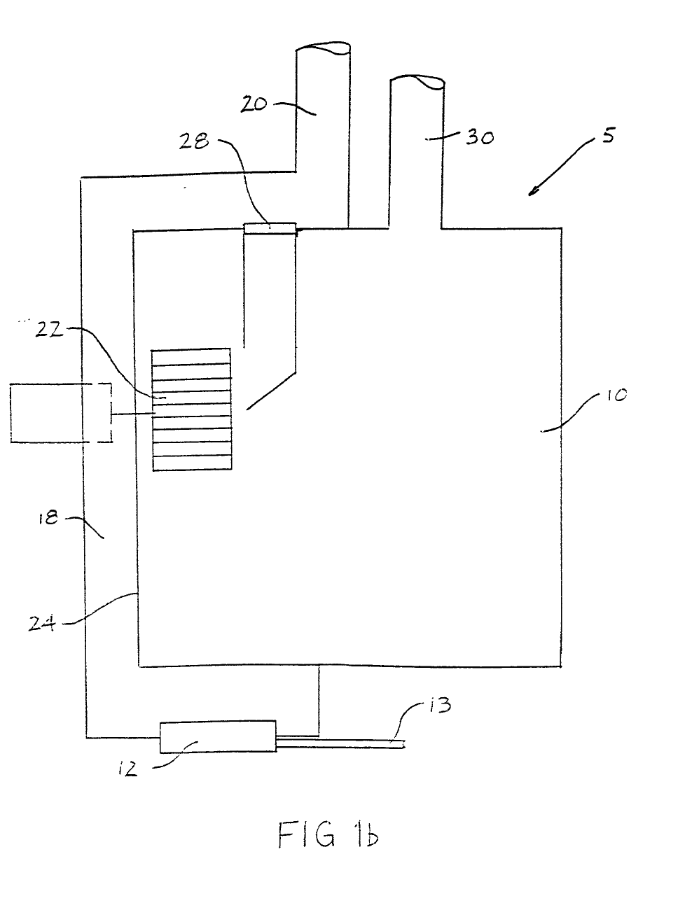

As shown in FIGS. 1a and 1b, convection oven 5 comprises a cooking chamber 10. Cooking chamber 10 can be of any suitable dimensions to accommodate food prepared to be cooked. A duct 18 is positioned adjacent cooking chamber 10 and preferably extends along at least a portion of a wall of cooking chamber 10, at least a portion of a floor of cooking chamber 10 and/or at least a portion of a ceiling of cooking chamber 10.

Duct 18 has a first end portion connected to an output end portion of a gas combustion system 12 and a second end portion which extends into cooking chamber 10. Gas combustion system 12 is mounted with respect to cooking chamber 10. According to different embodiments of this invention, gas combustion system 12 may comprise an induced draft system, a forced draft system or a natural draft system. In one preferred embodiment of this invention, gas combustion system 12 comprises at least one burner 16 connected to a gas supply or fuel source 13, for example a natural gas supply.

Gas supply 13 supplies gas, preferably natural gas, to burner 16. The gas burns or combusts within burner 16 to produce or generate combustion products. The term “combustion products” as used throughout this specification and in the claims includes, but is not limited to, heat and combustion gas fumes.

In one preferred embodiment of this invention, a convection blower 22 is mounted within cooking chamber 10 and in communication with duct 18. In another preferred embodiment of this invention, convection blower 22 may be mounted within duct 18. Preferably, but not necessarily, convection blower 22 is rotated by a motor. Any conventional motor or other means known to those skilled in the art may be used to rotate convection blower 22. A flue 20 is connected to duct 18 and is in communication with ambient air outside convection oven 5.

A damper 28 is connected to duct 18. Damper 28 is moveable between a closed position, wherein damper 28 prevents passage of air through duct 18 into flue 20 as shown in FIG. 1a, and an open position, wherein damper 28 prevents passage of air through duct 18 into cooking chamber 10 as shown in FIG. 1b. Damper 28 may be actuated electronically, mechanically or in any other manner of actuation known to those having ordinary skill in the art.

As shown in FIG. 1a, when damper 28 is in the closed position, convection oven 5 is heated by a direct-fired combustion system. Gas supply 13 supplies gas to burner 16 where the gas combusts to generate combustion products. With damper 28 in the closed position, the combustion products generated by gas combustion system 12 are drawn through duct 18 by convection blower 22. As the combustion products travel through duct 18, heat may be transferred from within duct 18 into cooking chamber 10 via a heat exchanger 24, e.g. through the adjacent wall of duct 18, through the floor of cooking chamber 10 or through the ceiling of cooking chamber 10. As the combustion products are drawn into cooking chamber 10, the combustion products circulate through cooking chamber 10 and make direct contact with the food being cooked. After circulating through cooking chamber 10, the combustion products exit cooking chamber 10 through a vent 30 and into ambient air.

As shown in FIG. 1b, when damper 28 is in the open position, convection oven 5 is heated by an indirect-fired combustion system. As the combustion products generated by gas combustion system 12 travel through duct 18, heat is transferred from within duct 18 into cooking chamber 10 through heat exchanger 24. In one preferred embodiment of this invention, heat exchanger 24 is at least a portion of the inner wall of duct 18, at least a portion of the floor of cooking chamber 10 and/or at least a portion of the ceiling of cooking chamber 10. With damper 28 in the open position, the combustion products exit duct 18 through flue 20 and are prevented by damper 28 from flowing into cooking chamber 10. As the heat exchange occurs through heat exchanger 24, convection blower 22 circulates the heated air within cooking chamber 10. After circulating through cooking chamber 10, the circulated heated air can be reused or recirculated through cooking chamber 10, with any excess heated air exiting cooking chamber 10 through vent 30. In the indirect-fired combustion system, the combustion products do not directly contact the food being cooked.

Damper 28 is fail safe because in any position it will not permit the build up of combustion products. With damper 28 moveable between an open position and a closed position, a flue path will always be available either through flue 20 or vent 30.

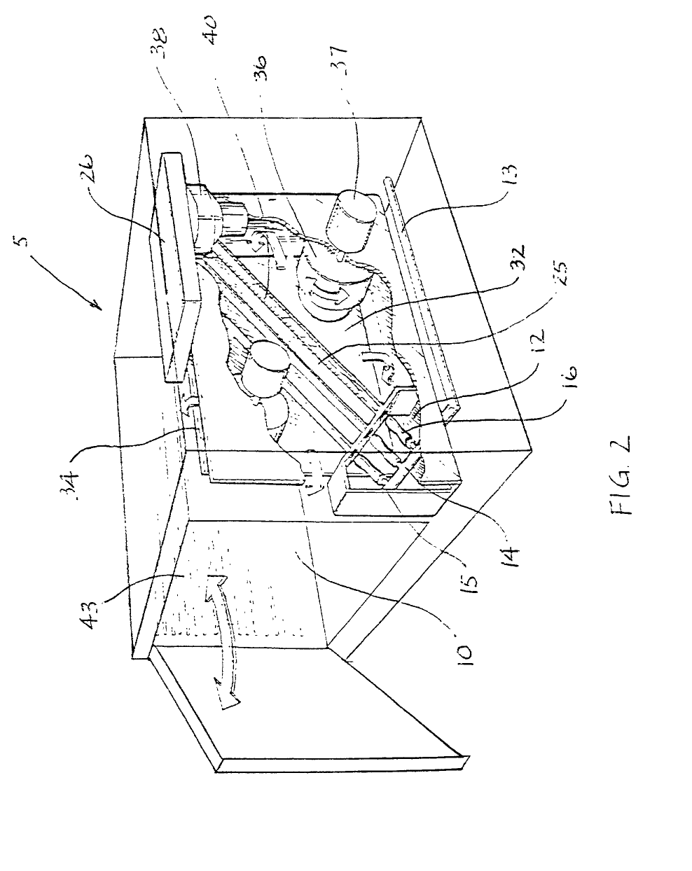

In another preferred embodiment of this invention as shown in FIG. 2, a separate heat exchange element 25 is provided. A blower plenum 32 is preferably positioned adjacent and in communication with cooking chamber 10, as shown in FIG. 2. An inlet baffle 34 is positioned between blower plenum 32 and cooking chamber 10. Preferably, inlet baffle 34 has a plurality of apertures 43.

According to one preferred embodiment of this invention, a gas combustion system 12 is mounted within blower plenum 32 to generate combustion products. As shown in FIG. 2, gas combustion system 12 comprises a gas manifold 14 connected to gas supply 13 and having at least one gas outlet 15, preferably at least three gas outlets 15. It is apparent to those skilled in the art that any number of gas outlets 15 can be used in gas combustion system 12. A control valve (not shown in FIG. 2) is connected between gas manifold 14 and gas supply 13 to control the amount of gas supplied to gas combustion system 12. A burner 16 is connected to each gas outlet 15.

Heat exchange element 25, for example at least one heat exchange tube 40, is connected to each burner 16 at a first end portion of heat exchange tube 40. In one preferred embodiment of this invention, heat exchange element 25 is mounted within blower plenum 32 and comprises a plurality of heat exchange tubes 40, preferably at least three heat exchange tubes 40 corresponding to the number of burners 16 of gas combustion system 12. As shown in FIG. 2, a second end portion of each heat exchange tube 40 extends into a header 26.

Header 26 is in communication with gas supply 13 so that the combustion products produced in gas combustion system 12 travel through heat exchange element 25 and are collected within a volume of header 26. Header 26 is connected to an inducer 38 having a valve 39 (not shown in FIG. 2) that is moveable between a closed position, wherein convection oven 5 operates as a direct-fired combustion system, and an open position, wherein convection oven 5 operates as an indirect-fired combustion system. It is apparent that valve 39 can be actuated electronically, mechanically or by any other means known to those skilled in the art.

Preferably, at least one convection impeller 36, the same or similar to convection blower 22, is mounted within blower plenum 32 and mounted adjacent heat exchange element 25. In one preferred embodiment of this invention, convection oven 5 has two convection impellers 36 mounted within blower plenum 32, as shown in FIG. 2. Convection impeller 36 is driven by a motor 37. Other means known to those skilled in the art may be used to drive convection impeller 36.

With valve 39 in the closed position, the combustion products produced by gas combustion system 12 and collected within header 26 are in communication with cooking chamber 10. The combustion products are circulated within cooking chamber 10 by convection impeller 36 and directly contact the food being cooked.

With valve 39 in the open position, the combustion products produced by gas combustion system 12 and collected within header 26 are in communication with ambient air outside convection oven 5. Thus, the combustion products do not enter cooking chamber 10 and therefore do not directly contact the food being cooked.

Referring to FIG. 2, gas supplied by gas supply 13 to gas combustion system 12 travels through gas manifold 14 and is distributed to individual burners 16 via gas outlets 15. Within burner 16, the gas combusts and generates combustion products. The combustion products travel through heat exchange element 25, for example at least one heat exchange tube 40, as shown in FIG. 2. Convection impeller 36 generates airflow across heat exchange tubes 40 and heat is transferred from heat exchange tubes 40 to the air flowing across heat exchange tubes 40.

Heat exchange tubes 40 and convection impeller 36 are configured to provide high airflow rates over heat exchange tubes 40 and produce high heat transfer rates, reducing the surface area of individual heat exchange tubes 40 required for a desired heat exchange effectiveness.

The heated air is forced into cooking chamber 10 by convection impeller 36. Apertures 43 in inlet baffle 34 allow circulated air within cooking chamber 10 to flow into blower plenum 32 by at least one convection impeller 36. Convection impeller 36 recirculates the air across heat exchange element 25 to continue the cooking process whereby heat is transferred from heat exchange element 25 to the air flowing over heat exchange element 25 and then forced into cooking chamber 10 by convection impeller 36.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

What is claimed:

1. A convection oven, comprising:
a cooking chamber;
a gas combustion system mounted with respect to the cooking chamber, the gas combustion system generating combustion products;
a duct connecting the gas combustion system and the cooking chamber;
a flue connected to the duct;
a convection blower in communication with the duct;
a heat exchanger positioned between the duct and the cooking chamber; and
a damper connected to the duct, the damper moveable between an open position wherein the combustion products are in communication with the flue and a closed position wherein the combustion products are in communication with the cooking chamber.

2. The convection oven of claim 1 wherein the gas combustion system comprises at least one burner connected to a fuel source.

3. The convection oven of claim 1 further comprising a vent in communication with the cooking chamber.

4. The convection oven of claim 1 wherein the damper is electrically actuated.

5. The convection oven of claim 1 wherein the damper is mechanically actuated.

6. The convection oven of claim 1 wherein the gas combustion system is in communication with the cooking chamber.

7. The convection oven of claim 1 wherein the gas combustion system is in communication with the flue.

8. The convection oven of claim 1 wherein the convection blower is mounted within the cooking chamber.

9. The convection oven of claim 1 wherein the gas combustion system comprises one of an induced draft system, a forced draft system and a natural draft system.

10. A convection oven, comprising:
a cooking chamber;
a blower plenum positioned adjacent the cooking chamber;
an inlet baffle positioned between the cooking chamber and the blower plenum, the cooking chamber thereby in communication with the blower plenum;
a gas combustion system mounted within the blower plenum, the gas combustion system generating combustion products;
a heat exchange element mounted within the blower plenum and connected to the gas combustion system;
a header connected to the heat exchange element;
at least one convection impeller mounted within the blower plenum; and
an inducer connected to the header, the inducer having a valve moveable between an open position wherein the combustion products are in communication with ambient air and a closed position wherein the combustion products are in communication with the cooking chamber.

11. The convection oven of claim 10, wherein the gas combustion system further comprises:
a gas manifold connected to a gas supply, the gas manifold having at least one gas outlet;
a burner connected at a first end portion to each gas outlet of the at least one gas outlets and connected at a second end portion to a heat exchange element.

12. The convection oven of claim 11, wherein the heat exchange element comprises a plurality of heat exchange tubes, each heat exchange tube of the plurality of heat exchange tubes having a first end portion connected to a burner and a second end portion connected to the header.

13. The convection oven of claim 10, further comprising a control valve connected between the gas manifold and the gas supply.

14. The convection oven of claim 10, wherein the inlet baffle has a plurality of apertures.
